(19) United States
(12) Patent Application Publication
(10) Pub. No.: US 2024/0034141 A1
(43) Pub. Date: Feb. 1, 2024

(54) VEHICLE BODY REAR STRUCTURE

(71) Applicant: HONDA MOTOR CO., LTD., Tokyo (JP)

(72) Inventors: Masayasu Yoshida, Wako-shi (JP); Satoru Kawabe, Wako-shi (JP); Hiroyo Miyanaga, Wako-shi (JP); Masaaki Tatsuwaki, Wako-shi (JP); Hisashi Suzuki, Wako-shi (JP)

(21) Appl. No.: 18/219,120

(22) Filed: Jul. 7, 2023

(30) Foreign Application Priority Data
Jul. 28, 2022 (JP) 2022-120354

(51) Int. Cl. B60K 1/04; B62D 21/02; B62D 21/15

(52) U.S. Cl. CPC B60K 1/04; B62D 21/02; B62D 21/152

(57) ABSTRACT

A vehicle body rear structure includes a battery disposed below a floor, a battery frame that covers a periphery of the battery and that has a rear frame part configured to cover at least a rear of the battery, a rear mounted part that is disposed behind the rear frame part and that is disposed at a height in which at least a part of the rear mounted part overlaps the rear frame part in a forward/rearward direction, and a reinforcement block that is supported by any one of frame members of a vehicle and that is disposed between the rear frame part and the rear mounted part, wherein the reinforcement block includes a guide surface inclined downward toward a front side in a region facing the rear mounted part at a front side of the rear mounted part.

### CROSS-REFERENCE TO RELATED APPLICATION

Priority is claimed on Japanese Patent Application No. 2022-120354, filed Jul. 28, 2022, the content of which is incorporated herein by reference.

### BACKGROUND OF THE INVENTION

### Field of the Invention

The present invention relates to a vehicle body rear structure.

### Description of Related Art

A vehicle body structure in which a battery is mounted below a floor of a vehicle body is known (for example, see Japanese Unexamined Patent Application, First Publication No. 2012-176751).

In the vehicle body structure disclosed in Japanese Unexamined Patent Application, First Publication No. 2012-176751, a rectangular battery frame is connected to a vehicle body frame below the floor, and a plurality of batteries are disposed inside the battery frame. The plurality of batteries are protected against an external load input by being surrounded by the battery frame.

### SUMMARY OF THE INVENTION

In the case of the above-mentioned vehicle body structure, rear mounted parts such as a spare tire, suspension parts, or the like, are disposed behind a mounting part of the battery frame of the vehicle body. For this reason, in the above-mentioned vehicle body structure, when an impact load is input from behind the vehicle body and the rear mounted parts are displaced significantly forward, there is a concern that the rear mounted parts will abut the rear frame part of the battery frame (the frame part that covers the rear side of the battery) and deform the rear frame part.

For this reason, in the above-mentioned vehicle body structure, in order to prevent the rear frame part from deforming significantly forward when an impact load is input from behind the vehicle body, it is necessary to increase the rigidity and strength of the rear frame part itself and the members around the rear frame part. However, raising the rigidity and strength thereof will lead to an increase in vehicle body weight and restrictions on the layout of other members.

An aspect of the present invention is directed to providing a vehicle body rear structure capable of protecting a battery against an input of an impact load from the rear without increasing rigidity and strength of a battery frame more than necessary. Then, as a result, the present invention increases collision safety of a vehicle body and contributes to development of a sustainable transportation system.

A vehicle body rear structure according to an aspect of the present invention includes a battery (for example, a battery (9) of an embodiment) disposed below a floor; a battery frame (for example, a battery frame (12) of the embodiment) that covers a periphery of the battery and that has a rear frame part (for example, a rear frame part (12r) of the embodiment) configured to cover at least a rear of the battery; a rear mounted part (for example, a spare tire (15) of the embodiment) that is disposed behind the rear frame part and that is disposed at a height in which at least a part of the rear mounted part overlaps the rear frame part in a forward/rearward direction; and a reinforcement block (for example, a reinforcement block (20) of the embodiment) that is supported by any one of frame members of a vehicle and that is disposed between the rear frame part and the rear mounted part, wherein the reinforcement block includes a guide surface (for example, a guide surface (20g) of the embodiment) inclined downward toward a front side in a region facing the rear mounted part at a front of the rear mounted part.

In the above-mentioned configuration, when an impact load is received by the rear part of the vehicle body and the rear mounted part is displaced toward the front of the vehicle body, the rear mounted part directly or indirectly abut the guide surface of the reinforcement block. Here, since the guide surface is inclined downward toward the front side, the rear mounted part is guided by the guide surface and is guided to below the rear frame part. As a result, it is possible to make the impact load input to the rear mounted part from behind the vehicle body difficult to apply a bending load with respect to the rear frame part.

The vehicle body rear structure may further include a pair of left and right rear side frames (for example, a rear side frame (7) of the embodiment) extending in a vehicle forward/rearward direction; and a cross member (for example, a cross member (13) of the embodiment) configured to connect the pair of rear side frames, wherein the reinforcement block has a front part which is coupled to the rear frame part, and a rear part which is coupled to the cross member or the rear side frame.

In this case, when the impact load is received by the rear part of the vehicle body and the rear mounted part abuts the guide surface of the reinforcement block, the abutting load is distributed to and supported by the rear frame part and the rear side frame of the battery frame. For this reason, the reinforcement block receives the input weight from the rear mounted part with high rigidity and guides the rear mounted part stably below the rear frame part.

In addition, since the reinforcement block connects the rear side frame and the rear frame part via the cross member or directly without going through the cross member, the impact load input from the rear part of the vehicle body to the rear side frame can also be distributed to and transmitted to the battery frame. For this reason, when this configuration is employed, impact absorption performance of the rear part of the vehicle body upon input of the impact load from behind the vehicle body can be further improved.

The reinforcement block may include a reinforcement wall (for example, a sidewall (20s) of the embodiment) having a bulging region (for example, a bulging region (21) of the embodiment) that bulges in a convex shape toward a front side of the vehicle with respect to the guide surface.

In this case, when the impact load is received by the rear part of the vehicle body and the rear mounted part abuts the guide surface of the reinforcement block, bending deformation of the reinforcement block toward the front of the vehicle body can be restricted by the bulging region of the reinforcement wall. For this reason, when the configuration is employed, the rear mounted part can be more stably guided below the rear frame part by the guide surface of the reinforcement block.

A curved part (for example, a curved part (7b) of the embodiment) which is bent or curved downward toward the front side may be provided on a front part of the rear side frame, and the reinforcement block or the cross member may be coupled to a vicinity of the curved part of the rear side frame.

In this case, when the impact load is input to the rear side frame from behind the vehicle body, the vicinity of the curved part of the rear side frame that easily becomes a folding starting part is reinforced by the reinforcement block via the cross member or directly without going through the cross member. For this reason, when the impact load is input to the rear side frame from behind the vehicle body, folding deformation of the rear side frame in the upward/downward direction using the bending part as a starting point can be restricted by the reinforcement block. Accordingly, when the configuration is employed, upon input of the impact load from the rear part of the vehicle body, it is possible to make the rear side frame stably collapse and to further increase impact absorption performance of the rear part of the vehicle body.

In the vehicle body rear structure according to the aspect of the present invention, the guide surface inclined forward and downward is provided in the region of the reinforcement block which faces the rear mounted parts in front of the rear mounted parts. For this reason, when the impact load is input from behind the vehicle body, the rear mounted parts can be guided below the rear frame part by the guide surface of the reinforcement block. Accordingly, when the configuration is employed, the battery can be protected against an impact load input from the rear without increasing the rigidity and strength of the battery frame more than necessary.

### BRIEF DESCRIPTION OF THE DRAWINGS

FIG. 1 is a longitudinal cross-sectional view of a rear part of a vehicle of an embodiment.

FIG. 2 is a bottom view of the rear part of the vehicle of the embodiment.

FIG. 3 is a partial cross-sectional perspective view of the rear part of the vehicle of the embodiment

FIG. 4 is a side view of the rear part of the vehicle of the embodiment.

FIG. 5 is a longitudinal cross-sectional view of the rear part of the vehicle of the embodiment showing a behavior of rear mounted parts (spare tire) when an impact load is input.

### DETAILED DESCRIPTION OF THE INVENTION

Hereinafter, an embodiment of the present invention will be described with reference to the accompanying drawings. Further, in the following description, directions of forward, rearward, upward, downward, leftward and rightward refer to directions with respect to a direction of advance of a vehicle body unless otherwise specified. In addition, at appropriate places in the drawings, an arrow FR indicates the forward direction of the vehicle body, an arrow UP indicates the upward direction of the vehicle body, and an arrow LH indicates the leftward direction of the vehicle body.

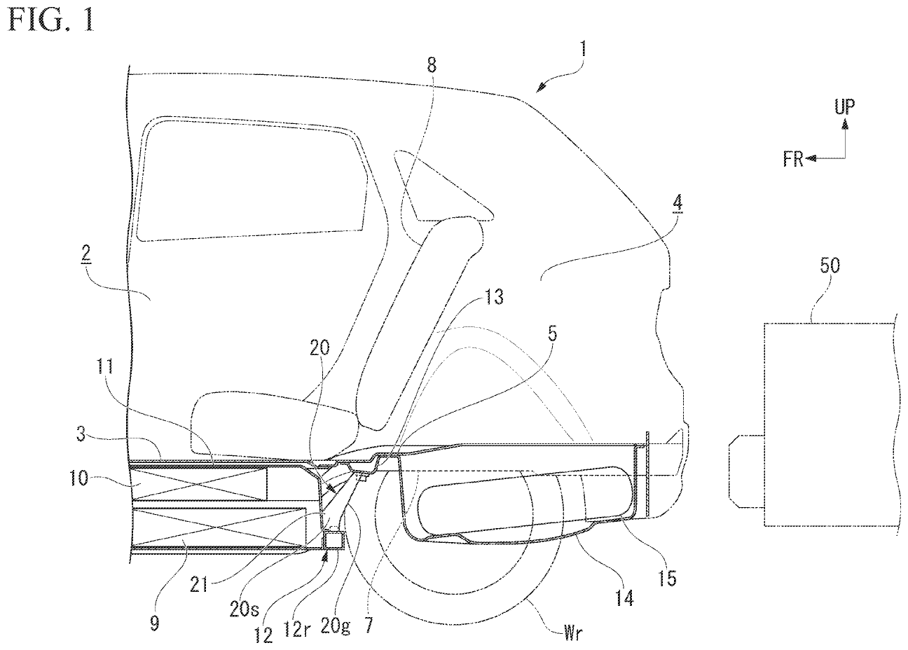

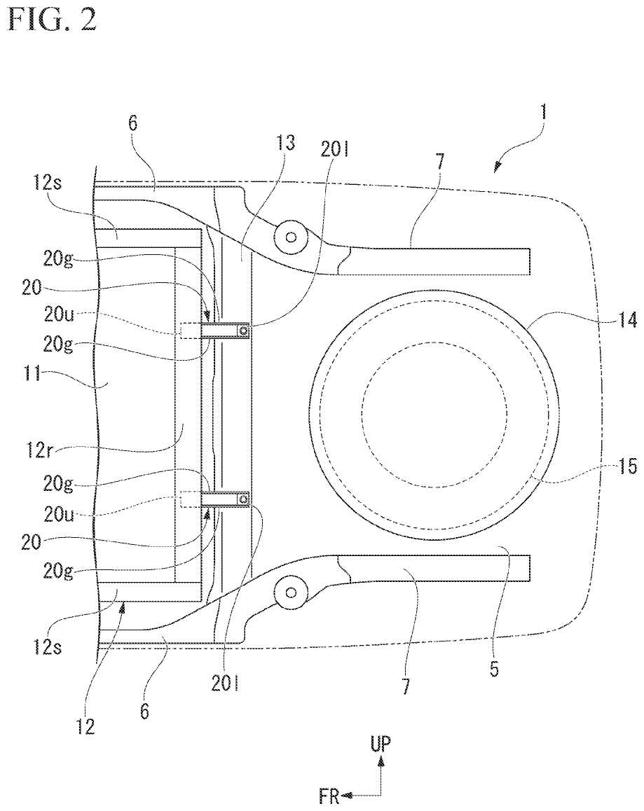

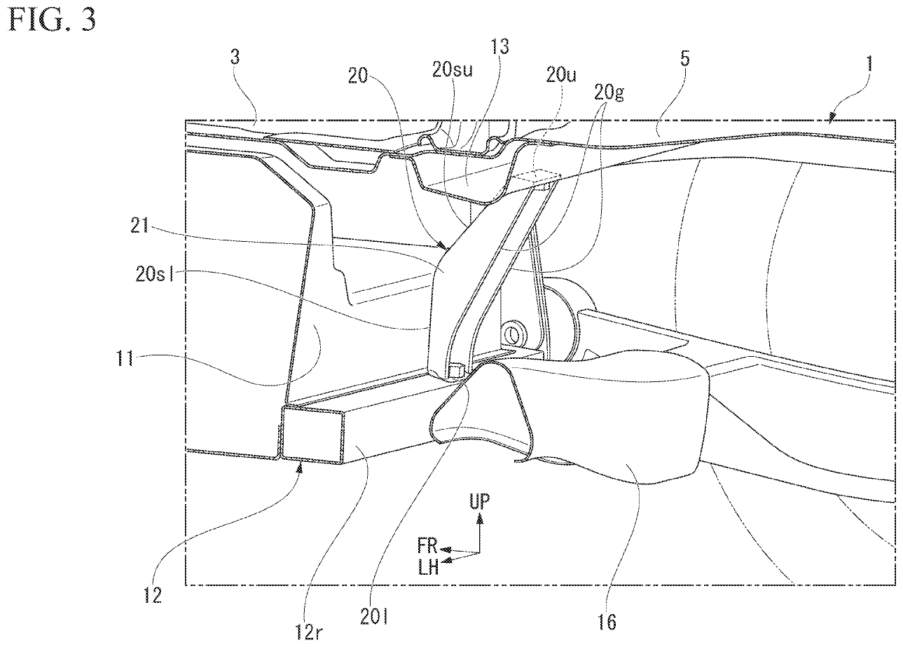

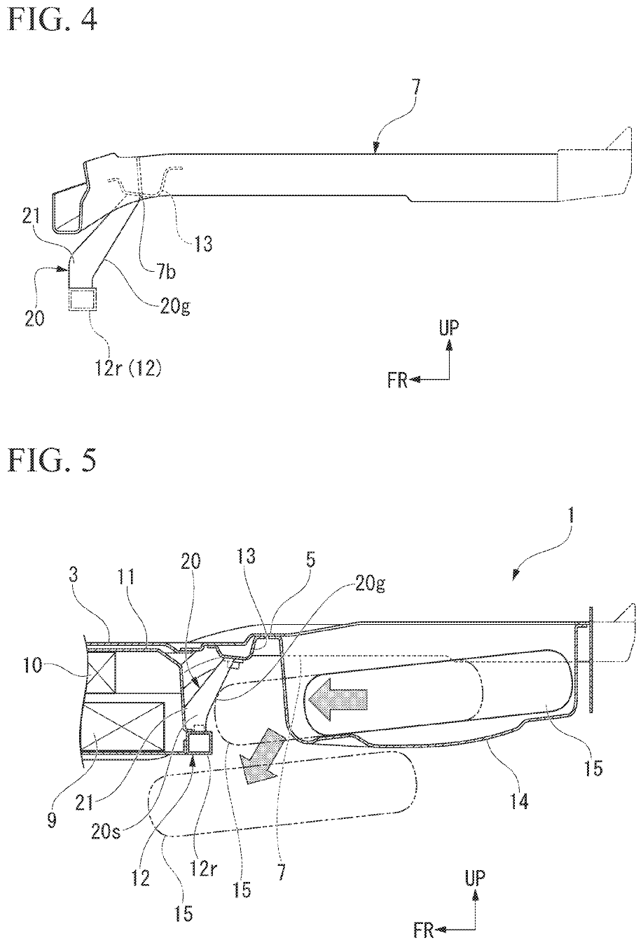

FIG. 1 is a longitudinal cross-sectional view of a rear part of a vehicle 1 of the embodiment in a direction perpendicular to a vehicle width direction. In addition, FIG. 2 is a bottom view of the rear part of the vehicle 1, and FIG. 3 is a partial cross-sectional perspective view of the rear part of the vehicle 1 in the direction perpendicular to the vehicle width direction. FIG. 4 is a view showing a lower frame part of the rear part of the vehicle 1 when seen from a left side.

A front floor 3 (floor) is disposed below a passenger compartment 2 of the vehicle 1, and a rear floor 5 is disposed below a cargo compartment 4 behind the passenger compartment 2. A pair of side sills 6 (see FIG. 2) extending in a vehicle body forward/rearward direction are disposed on left and right side portions below the passenger compartment 2.

Further, reference sign 8 in FIG. 1 designates a rear seat disposed on a rear part in the passenger compartment 2, and reference sign Wr designates a rear wheel of the vehicle 1.

A pair of left and right rear side frames 7 extending substantially in the vehicle body forward/rearward direction are disposed below the rear floor 5 of the cargo compartment 4. The pair of rear side frames 7 are spaced apart from each other in the vehicle width direction (leftward/rightward direction). Front parts of the left and right rear side frames 7 are curved outward and downward in the vehicle width direction toward the front of the vehicle body, and connected to rear end portions of the side sills 6 corresponding to the left and right sides. Portions (see FIG. 4) of the front parts of the rear side frames 7 curved downward toward the front of the vehicle body are referred to as “curved parts 7b.”

The left and right rear side frames 7 are connected to each other by a cross member 13 in the vicinity of the curved parts 7b of the front parts. The cross member 13 has a hat-shaped cross section that opens upward and extends in the vehicle width direction. The rear floor 5 is joined to the left and right rear side frames 7 and the cross member 13.

As shown in FIG. 1, a plurality of batteries 9 are mounted below the front floor 3 together with a battery control instrument 10 or the like. The batteries 9 are, for example, high voltage batteries configured to drive a motor for driving a vehicle body. The plurality of batteries 9 are accommodated in a casing 11 together with the battery control instrument 10 or the like, and supported by a rectangular battery frame 12 in this state.

Further, the batteries 9 are not limited to the high voltage batteries configured to drive the motor for driving the vehicle body. The batteries 9 may be motors configured to drive auxiliary equipment other than the motor for driving the vehicle body.

The battery frame 12 has a rear frame part 12r configured to cover outer peripheries of the plurality of batteries 9 and cover at least the rear of the batteries 9. The rear frame part 12r extends in the vehicle width direction and is connected to left and right side frame parts 12s (see FIG. 2) of the battery frame 12. The battery frame 12 is connected to the left and right side sills 6, a front cross member (not shown), or the like, via a connecting member (not shown).

A tire pan 14 recessed in a downward concave shape is formed in a central portion of the rear floor 5. A spare tire 15 can be stored horizontally in the tire pan 14. In the embodiment, a bottom surface of the tire pan 14 is inclined downward toward the front. For this reason, the spare tire 15 stored horizontally in the tire pan 14 is maintained in a posture in which the front part side is inclined downward. At least a part (for example, a front part of a central region in the vehicle width direction) of the spare tire 15 accommodated in the tire pan 14 in this way is disposed at a height position overlapping the rear frame part 12r of the battery frame 12 in the forward/rearward direction.

In addition, as shown in FIG. 3, suspension parts 16 such as a torsion beam or the like for suspending the rear wheel Wr are disposed on the rear frame part 12r of the battery frame 12 on the rear side of the vehicle body. At least some of the suspension parts 16 are disposed at a height overlapping the rear frame part 12r of the battery frame 12 in the forward/rearward direction.

In the embodiment, the spare tire 15 and the suspension parts 16 constitute the rear mounted parts. However, the rear mounted parts are not limited thereto. The rear mounted parts may be other parts as long as they are disposed behind the battery frame 12 and are weight parts moving forward together with deformation of the rear floor 5 when an impact load is input from behind the vehicle body.

Here, the rear frame part 12r of the battery frame 12 is disposed in front of and below the cross member 13 that connects the left and right rear side frames 7. The rear frame part 12r and the cross member 13 are connected by a pair of reinforcement blocks 20 that are spaced apart from each other in the vehicle width direction. Each of the reinforcement blocks 20 is disposed at a position at least partially overlapping the spare tire 15 and the suspension parts 16 that are the rear mounted parts in the forward/rearward direction. The reinforcement blocks 20 are disposed between the rear frame part 12r and the spare tire 15 or the suspension parts 16, which are the rear mounted parts.

Further, in the embodiment, the pair of (two) reinforcement blocks 20 are installed, but the number of the installed reinforcement blocks 20 is not limited to two, and may be one or three or more.

As shown in FIG. 3, the reinforcement blocks 20 include a pair of sidewalls 20s, front end portion sides of which are connected to each other by a connecting wall (not shown). The pair of sidewalls 20s stand in the vertical direction while being spaced apart by a fixed width in the vehicle width direction. The pair of sidewalls 20s form a substantially C-shaped horizontal cross-sectional shape together with the connecting wall on the side of the front end portion. A lower fastening wall 20l and an upper fastening wall 20u are connected to a lower end side and an upper end side of the pair of sidewalls 20s, respectively. The lower fastening wall 20l is fastened to the rear frame part 12r (for example, an upper wall of the rear frame part 12r) of the battery frame 12 by bolts. In addition, the upper fastening wall 20u is fastened to the cross member 13 (for example, a lower wall of the cross member 13) by bolts.

Further, while the lower fastening wall 20l is directly fastened to the rear frame part 12r of the battery frame 12 by bolts in the embodiment, a fastening piece may be fixed to the rear frame part 12r through welding or the like and the lower fastening wall 20l may be fastened to the fastening wall by bolts.

In addition, fixing of the reinforcement blocks 20 to the rear frame part 12r or the cross member 13 is not limited to the bolt fastening. The reinforcement blocks 20 may be fixed to, for example, the rear frame part 12r or the cross member 13 through welding, riveting, or the like.

Rear sides of the left and right sidewalls 20s of the reinforcement blocks 20 are inclined forward toward the down side from the upper end side. The inclined rear sides constitute a guide surface 20g inclined downward toward the front side in a region facing the rear mounted parts (the spare tire 15 or the suspension parts 16). Upon input of the impact load from behind the vehicle body, when the rear mounted parts (the spare tire 15 or the suspension parts 16) are largely displaced toward the front of the vehicle body, the rear mounted parts directly or indirectly abut the guide surfaces 20g of the reinforcement blocks 20.

In addition, the left and right sidewalls 20s of the reinforcement blocks 20 include lower front sides 20sl (see FIG. 3) extending vertically upward from the lower ends, and upper front sides 20su (see FIG. 3) extending diagonally rearward and further upward from the upper end portions of the lower front sides 20sl. The left and right sidewalls 20s constitute bulging regions 21 in which the vicinity of the boundary portion between the lower front side 20sl and the upper front side 20su bulges in a convex shape toward the front of the vehicle body with respect to the guide surface 20g that is a rear side. The bulging regions 21 of the sidewalls 20s constitute a bending restriction part configured to restrict bending deformation toward the front of the guide surfaces 20g of the reinforcement blocks 20.

Further, the sidewalls 20s of the reinforcement blocks 20 having the bulging regions 21 constitute the reinforcement wall according to the embodiment. The left and right sidewalls 20s of the reinforcement blocks 20 extend between the upper surface of the rear frame part 12r and the lower surface of the cross member 13, and overlaps the upper region of the rear surface of the casing 11 (an upper region of the rear frame part 12r) that accommodates the batteries 9 or the battery control instrument 10 in the front/rear direction.

FIG. 5 is a longitudinal cross-sectional view of a rear part of the vehicle 1 showing a behavior of the spare tire 15 when an impact load is input to the rear part of the vehicle 1 from behind.

Next, referring to FIG. 5, behavior and energy absorption of each part when an impact load is input to the rear part of the vehicle 1 from behind will be described. Further, the impact load is input to the rear part of the vehicle 1 from an object 50 (see FIG. 1) such as another vehicle body or the like.

When the impact load is input to the rear part of the vehicle body, the impact load is initially transmitted to the rear side frames 7 or the rear part of the rear floor 5 via the rear bumper or the like. Accordingly, the rear side frames 7 and the rear floor 5 undergo collapsing deformation from the rear part side, and the energy of the impact load is absorbed therebetween. Thus, when the impact load continues to be input from behind the vehicle body, the spare tire 15 or the suspension parts 16 inside the tire pan 14 are pushed from the rear part and displaced toward the front of the vehicle body.

Here, the spare tire 15 or the suspension parts 16 abuts the inclined guide surface 20g of the reinforcement block 20 when it is displaced by a predetermined amount or more, and as shown by an arrow in FIG. 5, it is guided by the guide surface 20g and displaced to the lower side of the rear frame part 12r of the battery frame 12. As a result, the spare tire 15 or the suspension parts 16 no longer apply large bends with respect to the rear frame part 12r. On the other hand, during this time, collapsing of the rear side frames 7 or the rear floor 5 advances, and the energy of the impact load is absorbed.

As described above, in the vehicle body rear structure of the embodiment, the reinforcement block 20 is disposed between the rear frame part 12r of the battery frame 12 and the rear mounted part (the spare tire 15, the suspension parts 16). Then, the guide surface 20g inclined downward toward the front side is provided in a region of the reinforcement block 20 facing the rear mounted part on the front side of the rear mounted part (the spare tire 15, the suspension parts 16). For this reason, when the impact load is input from behind the vehicle body, the rear mounted part can be guided below the rear frame part 12r by the guide surface 20g of the reinforcement block 20.

Accordingly, when the vehicle body rear structure of the embodiment is employed, the batteries 9 can be protected against an impact load input from the rear without increasing the rigidity and strength of the battery frame 12 more than necessary. Accordingly, by adopting the vehicle body rear structure of the embodiment, it is possible to increase the collision safety of the vehicle body and contribute to development of a sustainable transportation system.

In addition, in the vehicle body rear structure of the embodiment, the front part of the reinforcement block 20 is coupled to the rear frame part 12r of the battery frame 12, and the rear part of the reinforcement block 20 is coupled to the cross member 13. For this reason, when the impact load is received by the rear part of the vehicle body and the rear mounted part (the spare tire 15, the suspension parts 16) abuts the guide surface 20g of the reinforcement block 20, the abutting load can be distributed to and supported by the rear frame part 12r of the battery frame 12 and the rear side frame 7.

Accordingly, the front and rear of the reinforcement block 20 can be supported with high rigidity by the rear frame part 12r and the rear side frame 7. Accordingly, in the case in which the configuration is employed, when the impact load is input from behind the vehicle body, the input weight from the rear mounted part can be received with high rigidity by the reinforcement block 20, and the rear mounted part can be stably guided below the rear frame part 12r.

Further, in the vehicle body rear structure of the embodiment, since the front part of the reinforcement block 20 is coupled to the rear frame part 12r of the battery frame 12, and the rear part of the reinforcement block 20 is coupled to the cross member 13, the reinforcement block 20 connects the rear side frame 7 and the rear frame part 12r via the cross member 13.

Accordingly, when the configuration is employed, the impact load input from vehicle body rear part to the rear side frame 7 can also be distributed and transmitted to the battery frame 12. Accordingly, by employing the configuration, impact absorption performance of the rear part of the vehicle body upon input of the impact load from behind the vehicle body can be further increased.

In addition, in the vehicle body rear structure of the embodiment, the reinforcement blocks 20 include the sidewall 20s that is a reinforcement wall, and the bulging region 21 that bulges in a convex shape on the front side of the vehicle body with respect to the guide surface 20g of the rear part of the sidewall 20s is provided on the sidewall 20s. For this reason, when the impact load is received by the rear part of the vehicle body and the rear mounted part (the spare tire 15, the suspension parts 16) abuts the guide surface 20g of the reinforcement block 20, bending deformation of the reinforcement block 20 toward the front of the vehicle body can be restricted by the bulging region 21 of the sidewall 20s.

Accordingly, when the configuration is employed, the rear mounted part can be more stably guided below the rear frame part 12r by the guide surface 20g without incurring the bending deformation of the reinforcement block 20.

Further, in the vehicle body rear structure of the embodiment, the curved part 7b bent or curved forward and downward is provided on the front part of the rear side frame 7, and the cross member 13, to which the rear part of the reinforcement block 20 is connected, is coupled to the vicinity of the curved part 7b of the rear side frame 7. For this reason, when the impact load is input to the rear side frame 7 from behind the vehicle body, the vicinity of the curved part 7b of the rear side frame 7 that is likely to become a folding starting part is reinforced by the reinforcement block 20 via the cross member 13. Accordingly, when the impact load is input to the rear side frame 7 from behind the vehicle body, vertical folding deformation of the rear side frame 7 using the curved part 7b as starting point can be restricted.

Accordingly, when the configuration is employed, upon input of the impact load from the rear part of the vehicle body, it is possible to make the rear side frame 7 stably collapse from the rear part and to further improve the impact absorption performance of the rear part of the vehicle body.

Further, the present invention is not limited to the above-mentioned embodiment, and various design changes may be made without departing from the scope of the present invention.

For example, in the above-mentioned embodiment, the rear parts of the reinforcement blocks 20 are coupled to the cross member 13. However, the rear parts of the reinforcement blocks 20 may be coupled to other members than the cross member 13. For example, when the reinforcement blocks 20 are disposed in an outer region of a rear frame part 12f in the vehicle width direction, the rear parts of the reinforcement blocks 20 may be directly coupled to the vicinities of the bending parts of the rear side frames 7.

In this case, when the impact load is input from behind the rear side frames 7, bending deformation of the rear side frames 7 using bending parts 7b as starting points can be efficiently restricted by the reinforcement blocks 20 extending forward and downward.

In addition, the reinforcement blocks 20 do not necessarily have to be connected to the rear frame part 12r of the battery frame 12, and may be connected only to the cross member 13 or the rear side frames 7. Further, the reinforcement blocks 20 may be coupled to other vehicle body frames (frame members) than the cross member 13 or the rear side frames 7.

Further, while the reinforcement blocks 20 are formed in a substantially C-shaped cross-sectional shape by the left and right sidewalls 20s and the connecting wall in the above-mentioned embodiment, the shape of the reinforcement blocks 20 is not limited thereto. The reinforcement blocks 20 may have other shapes as long as they have the guide surfaces 20g inclined downwards towards the front in the region facing the rear mounted parts on the front side of the rear mounted parts. In addition, the reinforcement blocks 20 may be solid blocks.

In addition, in the above-mentioned embodiment, the lower ends of the reinforcement blocks 20 are fixed to the upper wall of the rear frame part 12r of the battery frame 12, and the guide surfaces 20g of the reinforcement blocks 20 are disposed above the upper wall of the rear frame part 12r. However, the guide surfaces 20g of the reinforcement blocks 20 may extend to a position where the rear surface of the rear frame part 12r is covered from the rear.

In this case, when the impact load is input from behind the vehicle body, the rear mounting member can be smoothly guided by a lower side of the rear frame part 12r.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicle body rear structure comprising:
a battery disposed below a floor;
a battery frame that covers a periphery of the battery and that has a rear frame part configured to cover at least a rear of the battery;
a rear mounted part that is disposed behind the rear frame part and that is disposed at a height in which at least a part of the rear mounted part overlaps the rear frame part in a forward/rearward direction; and
a reinforcement block that is supported by any one of frame members of a vehicle and that is disposed between the rear frame part and the rear mounted part,
wherein the reinforcement block includes a guide surface inclined downward toward a front side in a region facing the rear mounted part at a front side of the rear mounted part.

2. The vehicle body rear structure according to claim 1, further comprising:
a pair of left and right rear side frames extending in a vehicle forward/rearward direction; and
a cross member configured to connect the pair of rear side frames,
wherein the reinforcement block has a front part which is coupled to the rear frame part, and a rear part which is coupled to the cross member or the rear side frame.

3. The vehicle body rear structure according to claim 2, wherein the reinforcement block includes a reinforcement wall having a bulging region that bulges in a convex shape toward a front side of the vehicle with respect to the guide surface.

4. The vehicle body rear structure according to claim 3, wherein a curved part which is bent or curved downward toward the front side is provided on a front part of the rear side frame, and
the reinforcement block or the cross member is coupled to a vicinity of the curved part of the rear side frame.
